(19) United States
(12) Patent Application Publication
(10) Pub. No.: US 2022/0085704 A1
(43) Pub. Date: Mar. 17, 2022

(54) SYSTEM AND METHOD FOR MANUFACTURING STATOR ASSEMBLY

(71) Applicants: Hyundai Motor Company, Seoul (KR); Kia Corporation, Seoul (KR)

(72) Inventors: Jongho SHIN, Siheung-Si (KR); Seongjun PARK, Seongnam-Si (KR)

(73) Assignees: Hyundai Motor Company, Seoul (KR); Kia Corporation, Seoul (KR)

(21) Appl. No.: 17/357,847

(22) Filed: Jun. 24, 2021

(30) Foreign Application Priority Data
Sep. 14, 2020 (KR) 10-2020-0117527

(51) Int. Cl. H02K 15/12; B05D 3/02; B05D 3/04; B05D 7/00

(52) U.S. Cl. CPC H02K 15/12; B05D 7/542; B05D 3/0413; B05D 3/0218

(57) ABSTRACT

A system is provided for manufacturing a stator assembly having a stator core including a plurality of slots along a circumference of the stator core and a plurality of hairpins inserted into the slots, where the system may include, an epoxy coating stage disposed forward along a travel direction of the stator assembly, and configured to coat the epoxy on end portions of leg portions of the hairpins, and a varnish impregnation stage disposed at a rear of the epoxy coating stage along the travel direction of the stator assembly, and configured to impregnate varnish into external surfaces of the plurality of hairpins and also into an interior of the slot by flowing on the plurality of hairpins.

### CROSS-REFERENCE TO RELATED APPLICATION

The present application claims priority to Korean Patent Application No. 10-2020-0117527 filed on Sep. 14, 2020, the entire contents of which is incorporated herein for all purposes by this reference.

### BACKGROUND OF THE INVENTION

### Field of the Invention

The present invention relates to a system and method for manufacturing a stator assembly.

### Description of Related Art

Recently, a method for improving the output of a motor has been actively researched and developed to improve performance of electric vehicles.

In general, the output of the motor for a vehicle is known to be proportional to the number of turns of a stator coil wound on a stator core.

Accordingly, to improve the output of the motor without increasing the size of the motor, a method of increasing the space factor of the stator coil wound on the stator core may be considered.

As part of the above-described method, instead of using a circular coil having a circular cross-section, there is a trend to apply a flat coil having a rectangular cross-section.

However, in the case of flat coils, there are relative difficulties in winding coils compared to circular coils.

Therefore, as a method of facilitating winding in a flat coil, a type of motor (called a hairpin winding motor) has been provided, in which a plurality of separated hairpin type stator coils (hereinafter referred to as hairpins) are inserted into the stator core, and then respective hairpins are welded to form a coil winding part.

In the hairpin winding motor as described above, ‘U’-shaped hairpins are inserted into each slot of the stator core of a stator assembly, and then the hairpins disposed in each layer of each slot are welded to form a coil winding of the stator core.

At the present time, the hairpin includes a head portion and leg portions formed at both sides of the head portion. The hairpin is structured such that, when inserted into the slot of the stator core, the head portion and the leg portion extrude at opposite sides of the stator core.

A preset stage of the leg portion is formed as a welding portion for welding is formed, and the welding portion is a stage where the hairpin is stripped off.

Conventionally, before welding the welding portions exposed from the stator core, the impregnation process is first performed on the welding portion, and then epoxy is coated.

However, according to the conventional method, as the stator assembly is processed with repeated fastening/welding process, friction is applied to the hairpin, and as a result, a problem may often occur in that the defect that the epoxy of the welding portion having relatively weak strength is removed.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a system for manufacturing a stator assembly having a stator core including a plurality of slots along a circumference of the stator core and a plurality of hairpins inserted into the slots, where the system includes, an epoxy coating stage disposed forward along a travel direction of the stator assembly, and configured to coat epoxy on end portions of leg portions of the hairpins, and a varnish impregnation stage disposed at a rear of the epoxy coating stage along the travel direction of the stator assembly, and configured to impregnate varnish into external surfaces of the plurality of hairpins and also into an interior of the slot by flowing on the plurality of hairpins.

The epoxy coating stage may include, a first preheating device configured to preheat the stator assembly, an epoxy immersion device disposed at a rear of the first preheating device along the travel direction of the stator assembly, and configured to coat the epoxy on a preset range of the end portion of the leg portion of the hairpin by positioning the stator assembly such that leg portions of the hairpins face downward, and an epoxy coagulation device disposed at a rear of the epoxy immersion device along the travel direction of the stator assembly, and configured to coagulate the epoxy coated on the hairpin.

The epoxy immersion device may include an immersion tank storing epoxy powder. The epoxy immersion device may be configured such that, when the stator assembly is loaded such that the leg portion is contained inside the immersion tank, the epoxy powder is coated on the end portion of the leg portion by being blown by air blown from lower portion of the immersion tank.

The epoxy coating stage may be configured to transfer the stator assembly by a first rotation servo-motor.

The varnish impregnation stage may include, a second preheating device configured to preheat the stator assembly having passed through the epoxy coating stage, a varnish supplying device disposed at a rear of the second preheating device along the travel direction of the stator assembly, configured to position the stator assembly such that the leg portions of the hairpins face upward, and supply the varnish such that the varnish flows on the external surface of the hairpin to impregnate the interior of the slot, and a varnish coagulation device disposed at a rear of the varnish supplying device along the travel direction of the stator assembly, and configured to coagulate the varnish.

The second preheating device may be configured to preheat the stator assembly through high frequency heating.

The second preheating device may further include a first weight measure sensor, and may be configured to measure an initial weight of the stator assembly by the first weight measure sensor.

The varnish supplying device may further include a second weight measure sensor, and may be configured to measure an impregnated weight of the stator assembly impregnated with the varnish by the second weight measure sensor.

The varnish impregnation stage may be configured to transfer the stator assembly by a second rotation servo-motor.

The exemplary system may further include a drying device disposed at a rear of the varnish impregnation stage along the travel direction of the stator assembly, and configured to dry the epoxy and the varnish by heated air.

An exemplary method is for manufacturing a stator assembly having a stator core including a plurality of slots along a circumference of the stator core and a plurality of hairpins inserted into the slots, where the method includes, coating epoxy on end portions of leg portions of the hairpins while passing through an epoxy coating stage, and impregnating varnish into external surfaces of the hairpin and an interior of the slot by the varnish flowing on the hairpin while passing through a varnish impregnation stage disposed at a rear of the epoxy coating stage along a travel direction of the stator assembly.

The coating epoxy on end portions of leg portions may include, preheating the stator assembly by a first preheating device, coating epoxy powder on end portions of the hairpins in the preheated stator assembly by blowing air in an immersion tank, the preheated stator assembly having been transferred from the first preheating device to the immersion tank by a first rotation servo-motor and being positioned such that the leg portions of the hairpins is contained inside the immersion tank and disposed to surface downward lower portion, and coagulating, by an epoxy coagulation device, the epoxy powder coated on the hairpin, the stator assembly having been transferred from an epoxy immersion device to the epoxy coagulation device by the first rotation servo-motor.

In the coating epoxy on end portions of leg portions, the stator assembly may be preheated at a temperature range of 160° C. to 180° C. for a preset period.

The impregnating varnish may include, transferring the stator assembly having passed through the epoxy coating stage to a second preheating device by a second rotation servo-motor, preheating the stator assembly by the second preheating device, and vertically dropping the varnish from above the stator assembly by a varnish supplying device such that the varnish may be coated on the external surfaces of the hairpins and also enter the interior of the slots by flowing on the external surfaces of the hairpins.

The impregnating varnish may further include measuring an initial weight of the stator assembly transferred to the second preheating device.

The impregnating varnish may further include measuring an impregnated weight of the stator assembly after impregnating the varnish by the varnish supplying device.

In the impregnating varnish, the varnish may be coagulated for a preset period at a temperature range of 150° C. to 200° C. by a varnish coagulation device.

The exemplary method may further include, after the impregnating varnish, drying the epoxy and the varnish at the drying device.

The drying the epoxy and the varnish may be configured to dry the epoxy and the varnish by heated air at a temperature range of 140° C. to 160° C.

According to an exemplary system and method for manufacturing a stator assembly according to various exemplary embodiments of the present invention, the varnish is impregnated after the epoxy is coated on the welding portion of the hairpin, and therefore, the epoxy may be prevented from being removed from the hairpin even if the varnish is damaged due to external impact.

According to an exemplary system and method for manufacturing a stator assembly according to various exemplary embodiments of the present invention, by adding the drying device at the end of the process, the drying process to dry the conventional epoxy and the drying process to dry the varnish may be integrated, and accordingly, the number of processes may be reduced and the manufacturing cost may be reduced.

Other effects which may be obtained or are predicted by an exemplary embodiment will be explicitly or implicitly described in a detailed description of the present invention. That is, various effects that are predicted according to an exemplary embodiment will be described in the following detailed description.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a stator assembly manufactured by a system and method for manufacturing a stator assembly according to various exemplary embodiments of the present invention.

FIG. 2 is a schematic diagram of a system for manufacturing a stator assembly according to various exemplary embodiments of the present invention.

FIG. 3 is a schematic diagram of an epoxy immersion device applied to a system for manufacturing a stator assembly according to various exemplary embodiments of the present invention.

FIG. 4 is a flowchart showing a method for manufacturing a stator assembly according to various exemplary embodiments of the present invention.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On the other hand, the invention(s) is/are intended to cover not only the exemplary embodiments of the present invention, but also various alternatives, modifications, equivalents and other embodiments, which may be included within the spirit and scope of the invention as defined by the appended claims.

Exemplary embodiments of the present application will be described more fully hereinafter with reference to the accompanying drawings, in which exemplary embodiments of the invention are shown. As those skilled in the art would realize, the described embodiments may be modified in various different ways, all without departing from the spirit or scope of the present invention.

To clarify the present invention, parts that are not related to the description will be omitted, and the same elements or equivalents are referred to with the same reference numerals throughout the specification.

In the following description, dividing names of components into first, second, and the like is to divide the names because the names of the components are the same as each other, and an order thereof is not particularly limited.

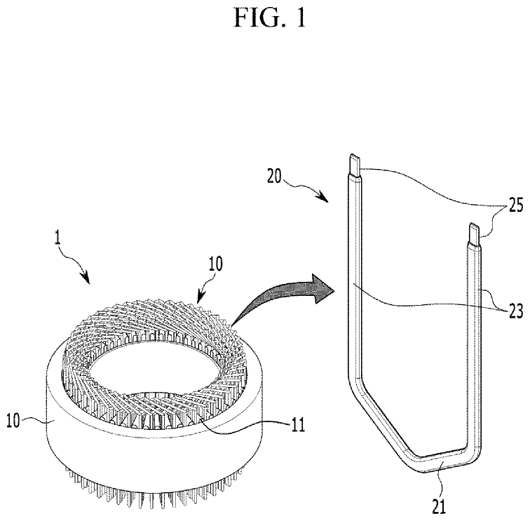

FIG. 1 is a perspective view of a stator assembly manufactured by a system and method for manufacturing a stator assembly according to various exemplary embodiments of the present invention.

Referring to FIG. 1, a system and method for manufacturing a stator assembly according to various exemplary embodiments of the present invention may be applied to impregnate varnish in a stator assembly 1 in which a hairpin 20 is arranged in a plurality of slots 11 formed in a circumferential direction of a stator core 10.

The stator core 10 is formed in a shape of a generally circular tube.

A rotor may be disposed inside the stator core 10, and the rotor may be configured to be rotatable about a rotation shaft.

In the stator core 10, the slots 11 may be formed along the circumference of the stator core 10.

Each slot 11 may be formed in a radial direction thereof.

The slots 11 may be formed in a multi-layered structure.

That is, the slot 11 may be formed in a plurality of layers in the radial direction of the stator core 10.

For example, four layers may be formed in each slot 11.

However, the number of layers formed in the slot 11 may be appropriately set depending on the motor output and winding design.

In the stator core 10, the slots 11 may be formed along the circumference of the stator core 10.

The hairpins 20 are inserted into respective layers of the slots 11.

The hairpins 10 may be formed in a generally U-shaped or V-shaped form.

While being inserted into the slots 11 of the stator core 10, adjacent hairpins 20 are interconnected to form a coil winding section.

The hairpins 20 are formed in a shape having two leg portions 23 at both sides of the head portion 21. Each hairpin 20 includes a head portion 21 and leg portions 23 formed at both sides of the head portion 21.

The leg portions 23 are inserted into corresponding slots 11 of the stator core 10.

Furthermore, while being inserted into the slots 11 of the stator core 10, the leg portion 23 partially extrudes from the slots 11 of the stator core 10.

Furthermore, a preset range of end portions of the leg portion 23 is formed as a welding portion 25 to be connected to the leg portion 23 of another hairpin 20.

At the present time, the welding portion 15 may be formed by peeling off a certain area of the end portion of the leg portion 23.

When the hairpin 20 is inserted into the slot 11 of the stator core 10, the extruding portion of the leg portion 23 of each hairpin 20 outwardly from the stator core 10 is bent or twisted along a circumference direction of the stator core 10.

Specific direction or angle at which the leg portion 23 of the hairpin 10 is bent may depend on details of winding design.

Furthermore, the leg portions 23 provided in the hairpin 20 may be bent in a same direction or in opposite directions.

Such bent hairpins 20 are welded to one another by the welding portions 25 formed at the preset range of the leg portions 23, to form electrical connection between the hairpins 20.

The system and method for manufacturing a stator assembly according to various exemplary embodiments of the present invention may be applied before bending or twisting the hairpins 20 inserted into the slots 11 of the stator core 10.

That is, according to the system and method for manufacturing a stator assembly, when the hairpin 20 is inserted into the stator core 10, epoxy is coated on the welding portion 25 of the hairpin 20, and varnish is impregnated on the external surface of the hairpin 20 and also on an interior of the stator core 10 by flowing on the hairpin 20. Accordingly, the hairpin 20 may be protected, and at the same time, the insulation effect of the stator assembly 1 excluding the welding portion 25 may be secured.

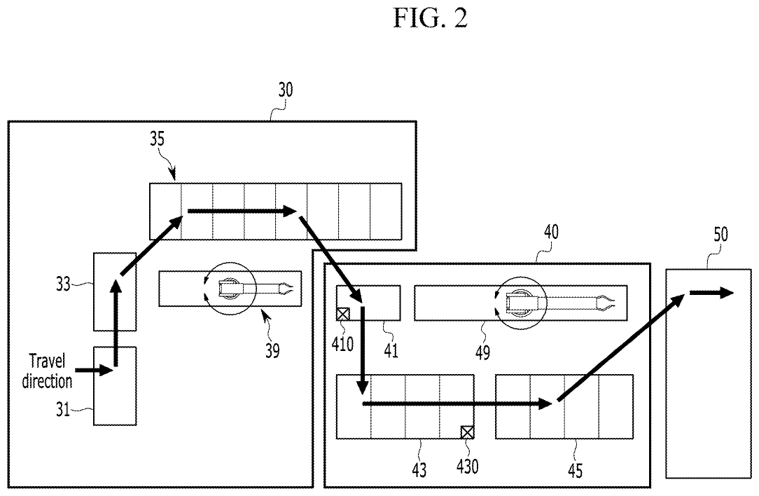

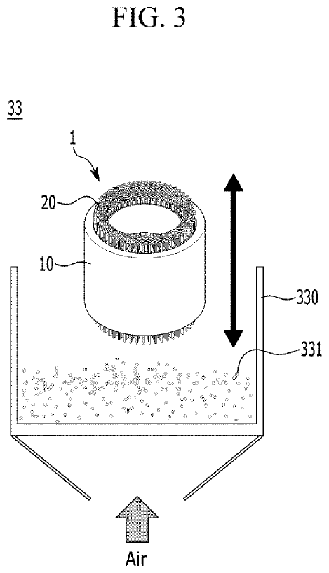

FIG. 2 is a schematic diagram of a system for manufacturing a stator assembly according to various exemplary embodiments of the present invention. FIG. 3 is a schematic diagram of an epoxy immersion device applied to a system for manufacturing a stator assembly according to various exemplary embodiments of the present invention.

Referring to FIG. 2, a system for manufacturing a stator assembly according to various exemplary embodiments of the present invention includes an epoxy coating stage 30 and a varnish impregnation stage 40.

The epoxy coating stage 30 is disposed forward along the travel direction of the stator assembly 1, and configured to coat the epoxy on end portions of leg portions 23 of the hairpins 20.

The varnish impregnation stage 40 is disposed at a rear of the epoxy coating stage 30, and configured to impregnate into the external surface of the hairpin 20 and also into the interior of the slot 11 by flowing on the hairpin 20.

The stator assembly 1 first passes through the epoxy coating stage 30, and then passes through the varnish impregnation stage 40.

The epoxy coating stage 30 includes a first preheating device 31, an epoxy immersion device 33, an epoxy coagulation device 35, and a first rotation servo-motor 39.

The first preheating device 31 is a device that preheats the stator assembly 1 when the stator assembly 1 with the hairpin 20 inserted into the stator core 10 is supplied.

The first preheating device 31 may preheat the stator assembly 1 at a preset temperature for a preset period.

Furthermore, the epoxy immersion device 33 is disposed at a rear of the first preheating device 31 along the travel direction of the stator assembly 1. The epoxy immersion device 33 is configured to coat the epoxy on a preset range of the end portion of the leg portion of the hairpin 20 by positioning the stator assembly 1 such that the leg portion 23 of the hairpin 20 faces downward.

That is, the epoxy immersion device 33 is a device to coat the epoxy on a preset range of the end portion of the leg portion 23 of the hairpin 20 inserted into the stator assembly 1 (refer to FIG. 3).

The epoxy immersion device 33 includes an immersion tank 330 storing epoxy powder 331.

The epoxy immersion device 33 is configured such that, when the stator assembly 1 is loaded such that the leg portion 23 is contained inside the immersion tank 330, the epoxy powder 331 is coated on the end portion of the leg portion 23 by being blown by air blown from lower portion of the immersion tank 330.

In the epoxy immersion device 33, the epoxy powder 331 in the powder state adheres to the external surface of the hairpin 20 preheated through the first preheating device 31, and becomes a gel state as it melts by the heat of the hairpin 20.

Furthermore, the epoxy coagulation device 35 is disposed at a rear of the epoxy immersion device 33 along the travel direction of the stator assembly 1, and configured to coagulate the epoxy coated on the hairpin 20.

That is, the epoxy coagulation device 35 is a device that hardens the gel state epoxy coated on the hairpin 20.

The epoxy coating stage 30 is configured such that the stator assembly 1 may be sequentially transferred through the first preheating device 31, the epoxy immersion device 33, and the epoxy coagulation device 35 by the first rotation servo-motor 39.

The first rotation servo-motor 39 is configured to move the stator assembly 1 by a preset angle and/or by a preset length.

Meanwhile, the varnish impregnation stage 40 includes a second preheating device 41, a varnish supplying device 43, a varnish coagulation device 45, and a second rotation servo-motor 49.

The second preheating device 41 preheats the stator assembly 1, which has passed the epoxy coating stage 30. That is, the second preheating device 41 is a device that preheats the stator assembly 1 for a preset period at a preset temperature when the stator assembly 1 having passed through the epoxy coagulation device 35 is supplied.

The second preheating device 41 is disposed at a rear of the epoxy coagulation device 35 along the travel direction of the stator assembly 1.

For example, the second preheating device 41 is configured to preheat the stator assembly 1 through high frequency heating.

At the present time, the second preheating device 41 includes a first weight measure sensor 410.

The first weight measure sensor 410 measures an initial weight of the stator assembly 1 when the stator assembly 1 is supplied to the second preheating device 41.

Furthermore, the varnish supplying device 43 is disposed at a rear of the second preheating device 41 along the travel direction of the stator assembly 1.

The varnish supplying device 43 positions the stator assembly such that the leg portions 23 of the hairpins 20 face upward, and supplies the varnish such that the varnish flows on the external surface the hairpin 20 to impregnate the interior of the slot 11.

That is, the varnish supplying device 43 is configured to supply the varnish in a liquid state in a trickling method, i.e., by vertically dropping the varnish by a preset amount from an upper portion of the stator assembly 1. Accordingly, the varnish may be coated on the external surface of the hairpin 20, and at the same time, may enter the interior of the slots 11, by flowing on the external surface of the hairpin 20.

At the present time, the varnish supplying device 43 includes a second weight measure sensor 430.

When the impregnation of the varnish into the stator assembly 1 by the varnish supplying device 43 is finished, the second weight measure sensor 430 measures an impregnated weight of the stator assembly 1.

The amount of impregnated varnish may be obtained as a difference between the initial weight measured by the first weight measure sensor 410 and the impregnated weight measured by the second weight measure sensor 430.

Furthermore, the varnish coagulation device 45 is disposed at a rear of the varnish supplying device 43 along the travel direction of the stator assembly 1, and configured to coagulate the varnish.

Furthermore, the varnish coagulation device 45 is configured to coagulate the varnish into the external surface of the hairpins 20 and the interior of the slot 11, by which the stator assembly 1 may be completed.

The varnish impregnation stage 40 is configured such that the stator assembly 1 may be sequentially transferred through the first preheating device 31, the varnish supplying device 43, and the varnish coagulation device 45 by the second rotation servo-motor 49.

The second rotation servo-motor 49 is configured to move the stator assembly 1 by a preset angle and/or by a preset length.

The stator assembly 1 having passed through the epoxy coating stage 30 and the varnish impregnation stage 40 is transferred to a drying device 50.

The drying device 50 is disposed at a rear of the varnish impregnation stage 40 along the travel direction of the stator assembly 1, disposed at a rear of the varnish coagulation device 45.

The drying device 50 is a device that dries the epoxy and the varnish together.

For example, the drying device 50 may dry the epoxy and the varnish through hot air.

An exemplary method for manufacturing the stator assembly 1 utilizes the system for manufacturing the stator assembly 1, and is hereinafter described in detail.

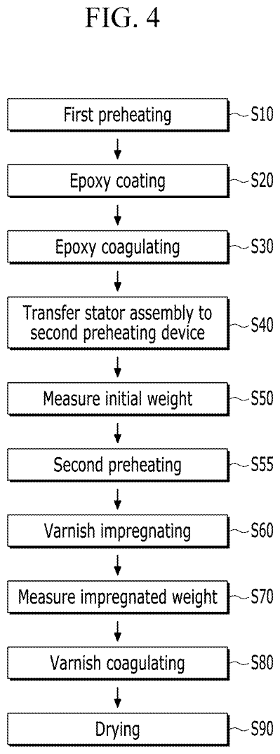

FIG. 4 is a flowchart showing a method for manufacturing a stator assembly according to various exemplary embodiments of the present invention.

The exemplary method for manufacturing a stator assembly may include, coating epoxy on end portions of leg portions of the hairpins while passing through an epoxy coating stage, and impregnating varnish into external surfaces of the hairpin and an interior of the slot by the varnish flowing on the hairpin while passing through a varnish impregnation stage disposed at a rear of the epoxy coating stage along a travel direction of the stator assembly.

Referring to FIG. 4, first at step S10, when the stator assembly 1 is supplied to the first preheating device 31, the first preheating device 31 preheats the stator assembly 1 at a temperature range of 160° C. to 180° C. for a preset period.

Subsequently, the preheated stator assembly 1 is transferred from the first preheating device 31 to the epoxy immersion device 33 by the first rotation servo-motor 39.

At the present time, the stator assembly 1 is disposed inside the immersion tank 330 such that the leg portions 23 of the hairpins 20 face downward.

Subsequently at step S20, air is blown from a lower portion (e.g., from a bottom) of the immersion tank 330.

Accordingly, the epoxy powder 331 stored in the immersion tank 330 is coated on a preset range of the end portions of the leg portions 23 of the hairpins 20,

At the present time, the epoxy powder that was originally in powder state experiences a phase change to a gel state by the heat of the preheated hairpin.

Subsequently, the stator assembly 1 coated with the epoxy is transferred from the epoxy immersion device 33 to the epoxy coagulation device 35 by the first rotation servo-motor 39.

At step S30, the gel-state epoxy which is coated on the hairpin 20 is coagulated by the epoxy coagulation device 35.

Subsequently at step S40, in the impregnation of the varnish, the stator assembly 1 having passed through the epoxy coating stage 30 is transferred to the second preheating device 41.

At step S50, an initial weight of the stator assembly 1 transferred to the second preheating device 41 is measured by the first weight measure sensor 410 included in the second preheating device 41.

Furthermore, at step S55, the stator assembly 1 is preheated by the second preheating device 41 for a preset period.

Subsequently, the stator assembly 1 is transferred from the second preheating device 41 to the varnish supplying device 43 by the second rotation servo-motor 49.

At step S60, the varnish is impregnated into external surfaces of the hairpins 20 and an interior of the slots 11.

At the step S60, the varnish is vertically dropped from above the stator assembly 1 by the varnish supplying device 43.

At the present time, as described above, the stator assembly 1 is positioned in the varnish supplying device 43 such that the leg portions 23 of the hairpins 20 face upward.

Therefore, at the step S60, the varnish is coated on the external surfaces of the hairpins 20 and simultaneously, enters into the interior of the stator core 10 by flowing on the external surface of the hairpin 20,

Subsequently at step S70, after impregnating the varnish by the varnish supplying device 43, an impregnated weight of the stator assembly 1 is measured by the second weight measure sensor 430 included in the varnish supplying device 43.

At the present time, the impregnated weight indicates the amount of varnish impregnated into the stator assembly 1 in comparison with the initial weight.

Accordingly, the stator assembly 1 is transferred from the varnish supplying device 43 to the varnish coagulation device 45 by the second rotation servo-motor 49.

At step S80, the varnish is coagulated by the varnish coagulation device 45.

At the present time, the varnish coagulation device 45 may coagulate the varnish for a preset period at a temperature range of 150° C. to 200° C.

Finally, the stator assembly 1 is transferred from the varnish coagulation device 45 to the drying device 50 by the second rotation servo-motor 49.

At step S90, the drying device 50 may dry the epoxy and the varnish by heated air at a temperature range of 140° C. to 160° C.

Therefore, according to a system and method for manufacturing a stator assembly according to various exemplary embodiments of the present invention, the varnish is impregnated after the epoxy is coated on the welding portion 25 of the hairpin 20, and therefore, the epoxy may be prevented from being removed from the hairpin 20 even if the varnish is damaged due to external impact.

Accordingly, according to the system and method for manufacturing a stator assembly, by changing the impregnation sequence of the varnish, the hairpin 20 may be protected while maintaining its durability.

Furthermore, according to the system and method for manufacturing a stator assembly according to various exemplary embodiments of the present invention, by adding the drying device 50 at the end of the process, the drying process to dry the conventional epoxy and the drying process to dry the varnish may be integrated, and accordingly, the number of processes may be reduced and the manufacturing cost may be reduced.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for manufacturing a stator assembly having a stator core including a plurality of slots along a circumference of the stator core and a plurality of hairpins inserted into the plurality of slots, the system comprising:
an epoxy coating stage disposed forward along a travel direction of the stator assembly, and configured to coat epoxy on end portions of leg portions of the plurality of hairpins; and
a varnish impregnation stage disposed at a rear of the epoxy coating stage along the travel direction of the stator assembly, and configured to impregnate varnish into external surfaces of the plurality of hairpins and also into an interior of the plurality of slots by flowing the vanish on the plurality of hairpins.

2. The system of claim 1, wherein the epoxy coating stage includes:
a first preheating device configured to preheat the stator assembly;
an epoxy immersion device disposed at a rear of the first preheating device along the travel direction of the stator assembly, and configured to coat the epoxy on a preset range of the end portions of the leg portions of the plurality of hairpins by positioning the stator assembly so that the leg portions of the plurality of hairpins face downward; and
an epoxy coagulation device disposed at a rear of the epoxy immersion device along the travel direction of the stator assembly, and configured to coagulate the epoxy coated on the plurality of hairpins.

3. The system of claim 2,
wherein the epoxy immersion device includes an immersion tank storing epoxy powder, and
wherein when the stator assembly is loaded so that the leg portions are contained inside the immersion tank, the epoxy powder is coated on the end portions of the leg portions by being blown by air blown from lower portion of the immersion tank of the epoxy immersion device.

4. The system of claim 2, wherein the epoxy coating stage is configured to transfer the stator assembly by a first rotation servo-motor.

5. The system of claim 1, wherein the varnish impregnation stage includes:
a second preheating device configured to preheat the stator assembly having passed through the epoxy coating stage;
a varnish supplying device disposed at a rear of the second preheating device along the travel direction of the stator assembly, configured to position the stator assembly so that the leg portions of the plurality of hairpins face upward, and supply the varnish so that the varnish flows on the external surfaces of the plurality of hairpins to impregnate the interior of the plurality of slots; and
a varnish coagulation device disposed at a rear of the varnish supplying device along the travel direction of the stator assembly, and configured to coagulate the varnish.

6. The system of claim 5, wherein the second preheating device is configured to preheat the stator assembly through high frequency heating.

7. The system of claim 5, wherein the second preheating device further includes a first weight measure sensor, and is configured to measure an initial weight of the stator assembly by the first weight measure sensor.

8. The system of claim 7, wherein the varnish supplying device further includes a second weight measure sensor, and is configured to measure an impregnated weight of the stator assembly impregnated with the varnish by the second weight measure sensor.

9. The system of claim 5, wherein the varnish impregnation stage is configured to transfer the stator assembly by a second rotation servo-motor.

10. The system of claim 1, further including a drying device disposed at a rear of the varnish impregnation stage along the travel direction of the stator assembly, and configured to dry the epoxy and the varnish by heated air.

11. A method for manufacturing a stator assembly having a stator core including a plurality of slots along a circumference of the stator core and a plurality of hairpins inserted into the plurality of slots, the method comprising:
coating epoxy on end portions of leg portions of the plurality of hairpins while passing through an epoxy coating stage; and
impregnating varnish into external surfaces of the plurality of hairpins and an interior of the plurality of slots by the varnish flowing on the plurality of hairpins while passing through a varnish impregnation stage disposed at a rear of the epoxy coating stage along a travel direction of the stator assembly.

12. The method of claim 11, wherein the coating epoxy on end portions of leg portions includes:
preheating the stator assembly by a first preheating device;
coating epoxy powder on the end portions of the plurality of hairpins in the preheated stator assembly by blowing air in an immersion tank, the preheated stator assembly having been transferred from the first preheating device to the immersion tank by a first rotation servo-motor and being positioned so that the leg portions of the plurality of hairpins is contained inside the immersion tank and disposed to face downward; and
coagulating, by an epoxy coagulation device, the epoxy powder coated on the plurality of hairpins, the stator assembly having been transferred from an epoxy immersion device to the epoxy coagulation device by the first rotation servo-motor.

13. The method of claim 12, wherein, in the coating epoxy on end portions of leg portions, the stator assembly is preheated at a temperature range of 160° C. to 180° C. for a preset period.

14. The method of claim 11, wherein the impregnating varnish includes:
transferring the stator assembly having passed through the epoxy coating stage to a second preheating device by a second rotation servo-motor;
preheating the stator assembly by the second preheating device; and
vertically dropping the varnish from above the stator assembly by a varnish supplying device so that the varnish is coated on the external surfaces of the plurality of hairpins and also enter the interior of the plurality of slots by flowing the vanish on the external surfaces of the plurality of hairpins.

15. The method of claim 14, wherein the impregnating varnish further includes measuring an initial weight of the stator assembly transferred to the second preheating device.

16. The method of claim 15, wherein the impregnating varnish further includes measuring an impregnated weight of the stator assembly after impregnating the varnish by the varnish supplying device.

17. The method of claim 16, wherein, in the impregnating varnish, the varnish is coagulated for a preset period at a temperature range of 150° C. to 200° C. by a varnish coagulation device.

18. The method of claim 11, further including, after the impregnating varnish, drying the epoxy and the varnish at the drying device.

19. The method of claim 18, wherein the drying the epoxy and the varnish is configured to dry the epoxy and the varnish by heated air at a temperature range of 140° C. to 160° C.
